(19) United States
(12) Patent Application Publication
(10) Pub. No.: US 2017/0193779 A1
(43) Pub. Date: Jul. 6, 2017

(54) APPARATUS, SYSTEM, AND METHOD FOR FACILITATING MOBILE TAG READER POSITIONAL CONFIDENCE

(71) Applicant: Checkpoint Systems, Inc., Thorofare, NJ (US)

(72) Inventors: Robert Joseph Langer, Delran, NJ (US); William Shuff, Swedesboro, NJ (US)

(21) Appl. No.: 14/985,076

(22) Filed: Dec. 30, 2015

(51) Int. Cl. G08B 13/24

(52) U.S. Cl. CPC G08B 13/2462

(57) ABSTRACT

A mobile tag reader that may be configured to wirelessly communicate with a security tag is provided. The mobile tag reader may include processing circuitry. The processing circuitry may be configured to determine a position of the mobile tag reader in the monitoring environment. The processing circuitry may be further configured to determine a position of the security tag in the monitoring environment based on the mobile tag reader position. The processing circuitry may be further configured to in response to a loss of confidence in the mobile tag reader position, execute a location estimating routine to determine an estimated mobile tag reader position.

### TECHNICAL FIELD

Various example embodiments relate generally to retail product inventory and security, and, more particularly, to methods and devices for improving location accuracy of security tag readers employed for such purposes.

### BACKGROUND

It is important for retailers to have accurate inventory information regarding products (or items) in their stores so that they can take actions to ensure that they have the correct number of items available to sell to customers. In some cases, it is also important for retail stores to also have accurate inventory within various specific locations in their stores. For example, an accurate total store inventory may be used to determine when items should be ordered from sources external to the store (e.g., from distribution centers, direct from vendors, or from third party logistic providers, etc.). Within the store, an accurate inventory in a selling floor location may be used to determine when items should be moved from a backroom to the selling floor location so that the items are available for customers to purchase.

Retailers typically count items within various store locations to establish accurate inventory at a point in time. The retailers then track items exiting and entering the store location to keep a current idea of their inventory relative to the known value when the full count was conducted. In the past, inventory counting was largely performed with a heavy manual interaction component. However, more recently radio frequency identification (RFID) has become a useful tool for reducing the requirement for manual interaction with inventory counts.

In order to improve the ability of retailers to manage inventory, the devices and systems which they operate are continuously being improved. For example, various improvements may be introduced to attempt to improve location accuracy or to carry out certain specific desired functions related to detecting tags.

In some cases, the processing power, memory, or other components that impact the capability of systems or devices to handle computational loads may be somewhat limited. Thus, although fairly complex methods for improving location accuracy have been determined in the past, it is important for some applications to choose a locationing method that provides good performance without providing a heavy computational burden on the systems and devices that are available for use.

### BRIEF SUMMARY OF SOME EXAMPLES

Some example embodiments may provide a security tag reader that can maximize or increase its positional confidence within a retail space, but also that is not computationally burdensome.

In one example embodiment, a mobile tag reader that may be configured to wirelessly communicate with a security tag is provided. The mobile tag reader may include processing circuitry. The processing circuitry may be configured to determine a position of the mobile tag reader in the monitoring environment. The processing circuitry may be further configured to determine a position of the security tag in the monitoring environment based on the mobile tag reader position. The processing circuitry may be further configured to in response to a loss of confidence in the mobile tag reader position, execute a location estimating routine to determine an estimated mobile tag reader position.

According to another example embodiment, a location estimating system is provided. The security system may include at least one security tag disposed on a product in a monitoring environment; and at least one mobile tag reader configured to wirelessly communicate with a security tag. The mobile tag reader may include processing circuitry. The processing circuitry may be configured to determine a position of the mobile tag reader in the monitoring environment. The processing circuitry may be further configured to determine a position of the security tag in the monitoring environment based on the mobile tag reader position. The processing circuitry may be further configured to in response to a loss of confidence in the mobile tag reader position, execute a location estimating routine to determine an estimated mobile tag reader position.

In another example embodiment, a method of performing location estimation for a tag reader is provided. The method may include determining a position of the mobile tag reader in the monitoring environment. The method may further include determining a position of the security tag in the monitoring environment based on the mobile tag reader position. Even further, the method may include in response to a loss of confidence in the mobile tag reader position, executing a location estimating routine to determine an estimated mobile tag reader position.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a conceptual diagram of a monitoring environment within a retail store in which a mobile tag reader may be employed according to an example embodiment;

FIG. 2 illustrates a further conceptual diagram of a monitoring environment within a retail store in which a mobile tag reader may be employed according to an example embodiment;

FIG. 3 illustrates a block diagram of a mobile tag reader according to an example embodiment;

FIG. 4 illustrates a conceptual diagram of a monitoring environment within a retail store in which a mobile tag reader is executing a location estimating routine according to an example embodiment;

FIG. 5 illustrates a block diagram showing a control flow representative of a location estimating routine executable at a mobile tag reader according to an example embodiment; and

FIG. 6 illustrates a block diagram of a method of performing a location estimation for a mobile tag reader according to an example embodiment.

### DETAILED DESCRIPTION

Some example embodiments now will be described more fully hereinafter with reference to the accompanying drawings, in which some, but not all embodiments are shown. Indeed, the examples described and pictured herein should not be construed as being limiting as to the scope, applicability, or configuration of the present disclosure. Like reference numerals refer to like elements throughout. Furthermore, as used herein, the term “or” is to be interpreted as a logical operator that results in true whenever one or more of its operands are true. As used herein, “operable coupling” should be understood to relate to direct or indirect connection that, in either case, enables at least a functional interconnection of components that are operably coupled to each other.

As used herein, the terms “component,” “module,” and the like are intended to include a computer-related entity, such as but not limited to hardware, firmware, or a combination of hardware and software. For example, a component or module may be, but is not limited to being, a process running on a processor, a processor, an object, an executable, a thread of execution, and/or a computer. By way of example, both an application running on a computing device and/or the computing device can be a component or module. One or more components or modules can reside within a process and/or thread of execution and a component/module may be localized on one computer and/or distributed between two or more computers. In addition, these components can execute from various computer readable media having various data structures stored thereon. The components may communicate by way of local and/or remote processes such as in accordance with a signal having one or more data packets, such as data from one component/module interacting with another component/module in a local system, distributed system, and/or across a network such as the Internet with other systems by way of the signal. Each respective component/module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the components/modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Some example embodiments may enable provision of a system and device capable of monitoring, detecting, and locating security devices (e.g., tags) that are attached to objects such as retail products. In some cases, the tags may be radio frequency identification (RFID) tags. The tags may be read by a mobile tag reader (e.g., a robot, RFID reader, and/or the like) to allow the presence of the tag to be detected and identifying information on the tag to be read. As a mobile tag reader moves through a retail space and performs an inventory count, the mobile tag reader may be configured to determine its position and the tag's position. However, the mobile tag reader may detect unfamiliar or foreign objects as it moves through the retail space, and as a result, the mobile tag reader may lose confidence in its position. Instead of stopping the inventory count or returning to a known position when the mobile tag reader loses confidence in its position in the retail space, the mobile tag reader may execute a location estimating routine as it continues its inventory count. The location estimating routine may enable the mobile tag reader to estimate its position within the retail space, thereby increasing or restoring its positional confidence within the retail space. By being able to estimate its position in the retail space whenever the mobile tag reader's positional confidence diminishes, the mobile tag reader may become more effective and efficient when performing inventory counts.

In this regard, example embodiments may provide for a device and system that maximizes the positional confidence of the mobile tag reader. The location estimating routine and associated processes are simplified so that accurate locationing may be accomplished with relatively low computational power. In this regard, example embodiments may identify a subset of locating devices that appear to provide the highest quality position determining capability, and then employ a locating calculation or algorithm that greatly simplifies the location determination process, but still provides a relatively accurate locating result. A lighter-weight and potentially cheaper locating system may therefore be employed while still providing relatively accurate tag monitoring and locating capability. The addition of other functionalities that may be desired may therefore be employed with available resources that would otherwise be consumed by costly calculations associated with tag position determination.

An example embodiment will be described herein as it relates to a mobile tag reader that is configured to, in response to losing positional confidence, execute a location estimating routine so that it may estimate the mobile tag reader position in the monitoring environment. By estimating the mobile tag reader position in the monitoring environment, the mobile tag reader can boost or increase its positional confidence.

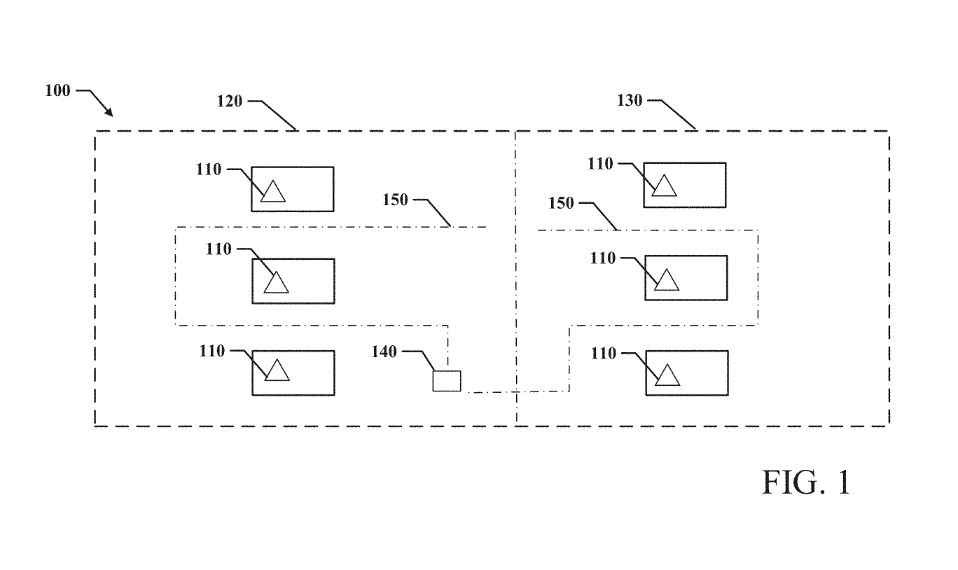

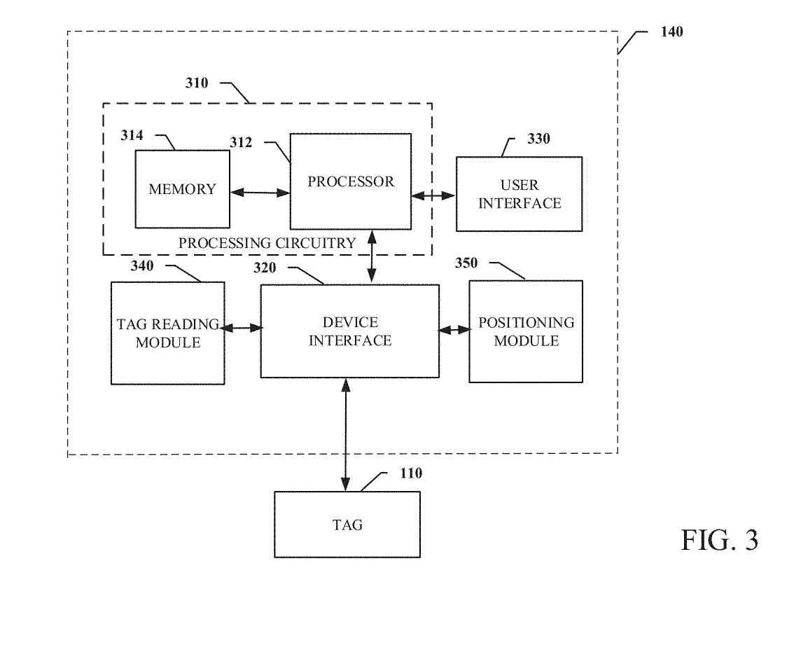

FIG. 1 illustrates a conceptual diagram of a monitoring environment 100 within a retail space in which a mobile tag reader 140 may be employed. As shown in FIG. 1, a mobile tag reader 140 may be used to locate and monitor tags 110 disposed on products that are located on shelves, displays, and/or the like in the monitoring environment 100. The mobile tag reader 140 may be controlled, at least in part, via a positioning module 350 and tag reading module 340 (see FIG. 3) located onboard the mobile tag reader 140, which will be described in greater detail below.

As further shown in FIG. 1, the monitoring environment 100 may include a first monitoring zone 120 and a second monitoring zone 130. The first monitoring zone 120 may represent one area of the store (e.g., the sales floor). The second monitoring zone 130 may represent another area of the store (e.g., the warehouse or product storage). The first and second monitoring zones 120 and 130 may be exclusively defined or, in some embodiments, the second monitoring zone 130 may exist within and overlap with the first monitoring zone 120. In some embodiments, the monitoring zones may be further divided into sub-zones. The sub-zones may be correlated with specific departments, locations, or product lines within the store, or alternatively be defined to divide the monitoring environment 100 into conveniently defined regions to facilitate detecting and locating tags 110 within particular regions. Even further, the monitoring environment 100 and respective monitoring zones and subzones may each be converted into a grid or coordinate system to facilitate determining an estimated mobile tag reader position.

The mobile tag reader 140 may move between the first and second monitoring zone 120 and 130 via a path 150 to detect tags 110 located in such zones. As the mobile tag reader 140 moves through the monitoring environment 100 on path 150 and detects tags 110 within the antenna pattern or coverage range of the mobile tag reader 140, the mobile tag reader 140 may store information associated with the detected tags 110, such as the determined position of each tag 110. In some cases, the position of the tags 110 may be defined in relation to a grid or coordinate system. Alternatively, or additionally, the mobile tag reader 140 may record its own position at various times and the corresponding tags 110 detected at each recorded position. In a further example embodiment, the mobile tag reader 140 may assign a confidence score to its determined position in the monitoring environment 100. When the mobile tag reader's confidence score is above a predetermined score, the mobile tag reader 140 has positional confidence, and when the mobile tag reader's confidence score is below a predetermined score, the mobile tag reader 140 loses positional confidence.

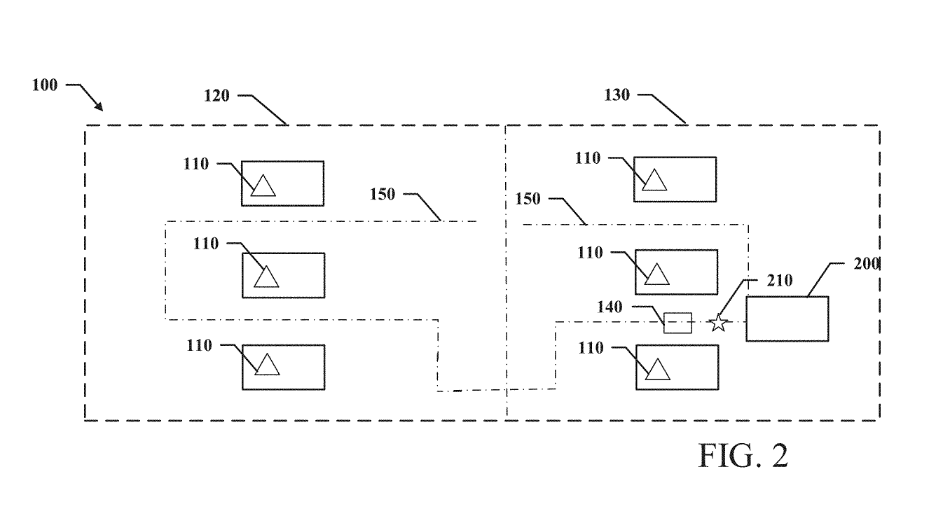

FIG. 2 illustrates a further conceptual diagram of a monitoring environment 100 in which the mobile tag reader 140 may be employed to detect the location of tags 110 within the monitoring environment 100. As shown in FIG. 2, the visual surroundings in the monitoring environment 100 may change over time. For example, an unfamiliar or foreign object may appear, in the monitoring environment 100, such as a new shelving unit 200 and/or the like. When the mobile tag reader 140 encounters this new shelving unit 200, the mobile tag reader 140 may lose positional confidence at position 210 because an obstruction has been added to the environment that was not previously present (e.g., during prior cycle counts or navigations through the monitoring environment 100). In response to losing positional confidence at position 210, the mobile tag reader 140 may perform a location estimating routine to boost its positional confidence above the predetermined score or threshold, without having to stop the inventory count or return to a known position in the monitoring environment 100 (i.e., a charging station).

The location estimating routine may include detecting tags 110 within the coverage range of the mobile tag reader 140 when positional confidence has been lost (e.g., fallen below a predefined threshold). The tags 110 that are read are then referenced against previously stored information of the tags 110. In some cases, the previously stored tag information is obtained from previous reads of the tags 110. For example, the mobile tag reader 140 will store information associated with a detected tag 110 as it performs an inventory count. This information may include the identity and position of the tag 110, position of the mobile tag reader 140, and/or the position of the mobile tag reader 140 when various tags 110, and more generally identifying information of the tags 110, are encountered. By storing this positional information, the mobile tag reader 140 can access it during the location estimating routine. In this regard, as the mobile tag reader 140 may additionally store positional information of tags associated with the new shelving unit 200 for use during future navigation of the mobile tag reader 140. If the tags 110 that are read match a previously stored tag 110, the information of the previously stored tags 110 may enable the mobile tag reader 140 to estimate its position within the monitoring environment 100, based on the positions of the read tags 110. By estimating its position within the monitoring environment 100, the mobile tag reader 140 may be able to increase its positional confidence.

If positional confidence is not increased by referencing the stored positional information of the tags 110 or the read tags 110 had no previously stored positional information, the mobile tag reader 140 may repeat the location estimating routine as it moves through the monitoring environment 100 until positional confidence is increased or, for example, a full inventory count cycle is complete, whichever comes first. A full inventory count cycle may be deemed complete when, for example, a given subset (e.g., a threshold amount) of the tags associated of the currently determined inventory have been read or the mobile tag reader 140 has moved about the monitoring environment 100 such that all areas of the monitoring environment 100 have attempted to be read.

In order to detect tags 110 within the monitoring environment 100, various forms of technology may be employed by the mobile tag reader 140. For example, angle of arrival (AOA) technology may be used. The mobile tag reader 140 may include at least one antenna and may be configured to read signals transmitted by the tag 110. Based on the signals read by the mobile tag reader 140, the mobile tag reader 140 may be configured to estimate an AOA and use the AOA to determine an estimated location of the tag 110. Even further, received signal strength indication (RSSI) technology may be used by the mobile tag reader 140. The mobile tag reader 140 may be include at least one antenna and may be configured to determine the power levels of signals transmitted by the tag 110 to use RSSI to determine the position of the tag 110. Based on the RSSI determined based on signals read by the mobile tag reader 140, the mobile tag reader 140 may be configured to estimate a location of the tag 110.

FIG. 3 illustrates a block diagram of a mobile tag reader 140. The mobile tag reader 140 may be configured to 1) detect and determine a position of one or more tags 110 located in a monitoring environment 100 and 2) determine its position in the monitoring environment 100 in accordance with an example embodiment. As shown in FIG. 3, mobile tag reader 140 may include processing circuitry 310 configured in accordance with an example embodiment as described herein. In this regard, for example, the mobile tag reader 140 may utilize the processing circuitry 310 to provide electronic control inputs to one or more functional units of the mobile tag reader 140 to receive, transmit, and/or process data associated with the one or more functional units and perform communications necessary to enable detecting, monitoring, and locationing of tags 110 and the mobile tag reader 140, and/or the like as described herein. In some embodiments, the processing circuitry 310 may be embodied as a chip or chip set. In other words, the processing circuitry 310 may comprise one or more physical packages (e.g., chips) including materials, components, and/or wires on a structural assembly (e.g., a baseboard). The structural assembly may provide physical strength, conservation of size, and/or limitation of electrical interaction for component circuitry included thereon. The processing circuitry 310 may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 310 may include one or more instances of a processor 312 and memory 314 that may be in communication with or otherwise control a device interface 320. As such, the processing circuitry 310 may be embodied as a circuit chip (e.g., an integrated circuit chip) configured (e.g., with hardware, software, or a combination of hardware and software) to perform operations described herein.

The device interface 320 may include one or more interface mechanisms for enabling communication with other devices (e.g., tag 110 and/or other devices). In some cases, the device interface 320 may be any means such as a device or circuitry embodied in either hardware, or a combination of hardware and software that is configured to receive and/or transmit data from/to devices or components in communication with the processing circuitry 310 via internal and/or external communication mechanisms. Accordingly, for example, the device interface 320 may further include wireless communication equipment (e.g., one or more antennas) for at least communicating with tags 110. The device interface 320 may therefore include one or more antenna arrays that may be configured or configurable to receive and/or transmit properly formatted signals associated with the tags 110. The device interface 320 may further include radio circuitry configured to encode and/or decode, modulate and/or demodulate, or otherwise process wireless signals received by or to be transmitted by the antenna array(s).

The processor 312 may be embodied in a number of different ways. For example, the processor 312 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 312 may be configured to execute instructions stored in the memory 314 or otherwise accessible to the processor 312. As such, whether configured by hardware or by a combination of hardware and software, the processor 312 may represent an entity (e.g., physically embodied in circuitry—in the form of processing circuitry 310) capable of performing operations according to embodiments of the present invention while configured accordingly. Thus, for example, when the processor 312 is embodied as an ASIC, FPGA or the like, the processor 312 may be specifically configured hardware for conducting the operations described herein. Alternatively, as another example, when the processor 312 is embodied as an executor of software instructions, the instructions may specifically configure the processor 312 to perform the operations described herein in reference to execution of an example embodiment.

In some examples, the processor 312 (or the processing circuitry 310) may be embodied as, include or otherwise control the operation of the mobile tag reader 140 based on inputs received by the processing circuitry 310. As such, in some embodiments, the processor 312 (or the processing circuitry 310) may be said to cause each of the operations described in connection with the mobile tag reader 140 in relation to operation of the mobile tag reader 140 relative to undertaking the corresponding functionalities associated therewith responsive to execution of instructions or algorithms configuring the processor 312 (or processing circuitry 310) accordingly.

In an exemplary embodiment, the memory 314 may include one or more non-transitory memory devices such as, for example, volatile and/or non-volatile memory that may be either fixed or removable. The memory 314 may be configured to store information, data, applications, instructions, or the like for enabling the processing circuitry 310 to carry out various functions in accordance with exemplary embodiments of the present invention. For example, the memory 314 may be configured to buffer input data for processing by the processor 312. Additionally or alternatively, the memory 314 may be configured to store instructions for execution by the processor 312. As yet another alternative or additional capability, the memory 314 may include one or more databases that may store a variety of data sets or tables useful for operation of the position estimator 300. Among the contents of the memory 314, applications or instruction sets may be stored for execution by the processor 312 in order to carry out the functionality associated with each respective application or instruction set. In some cases, the applications/instruction sets may include instructions for carrying out some or all of the operations described in reference to the calculations, algorithms, or flow charts described herein. In particular, the memory 314 may store executable instructions that enable the computational power of the processing circuitry 310 to be employed to improve the functioning of the mobile tag reader 140 relative to the functions described herein. As such, the improved operation of the computational components of the mobile tag reader 140 transforms the mobile tag reader 140 into a more capable device that can estimate its own position relative to stored positional data of read tags 110. The mobile tag reader 140 may therefore be configured (e.g., by instruction execution) to receive signals from the tag 110 and transform attributes of the received signals into data describing the location of the mobile tag reader 140 and the tags 110 to trigger other functionalities of the mobile tag reader 140.

In an example embodiment, the mobile tag reader 140 may also include a tag reading module 340. The mobile tag reader 140 may utilize the tag reading module 340 to detect and determine the position of the tag 110 based on wireless communications between the mobile tag reader 140 and the tag 110. For example, as described above, the tag reading module 340 may determine the position of the tag 110 as the mobile tag reader 140 moves throughout the monitoring environment 100. In an example embodiment, the position may be based on signal strength received from the tags 110. In some cases, the signal strength may be received RSSI technology. In a further example embodiment, the position may be based on estimating the AOA. If the mobile tag reader 140 loses positional confidence, the mobile tag reader 140 may execute a location estimating routine. In executing this routine, the mobile tag reader 140 may again utilize the tag reading module 340 to detect tags 110 within the coverage area of the mobile tag reader 140.

In an example embodiment, the mobile tag reader 140 may include a positioning module 350. The mobile tag reader 140 may utilize the positioning module 350 to determine the position of the mobile tag reader 140 as it moves through the monitoring environment. Even further, the positioning module 350 may define the navigational path of the mobile tag reader 140 as it moves throughout the monitoring environment 100. Positional determinations of the mobile tag reader 140 may be made using visual location, LIDAR, video object recognition and locationing, and/or the like. If the mobile tag reader 140 loses confidence in its position as it moves through the monitoring environment 100, the mobile tag reader 140 may also utilize the positioning module 350 to execute the location estimating routine according to an example embodiment.

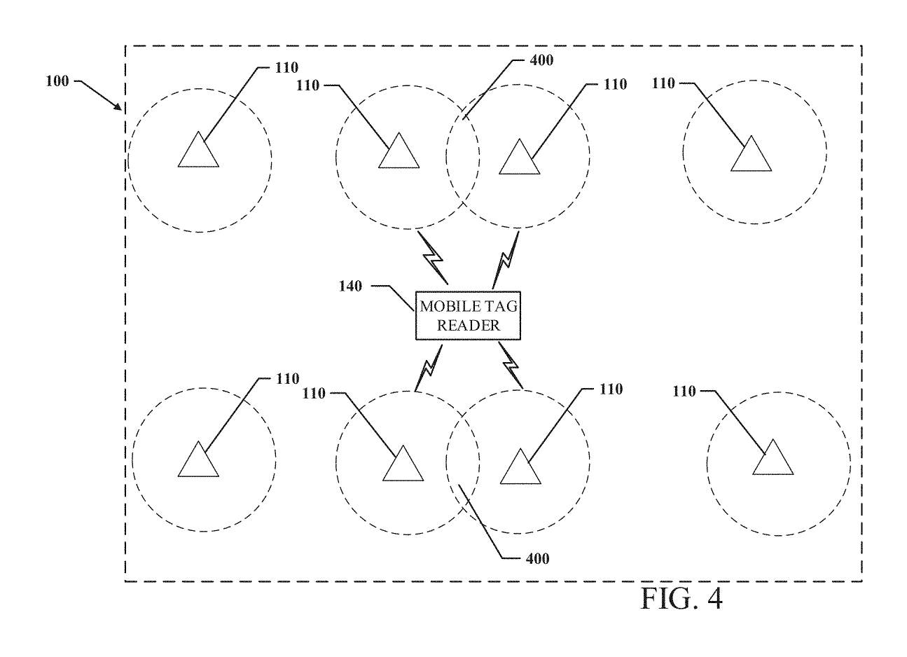

FIG. 4 illustrates a conceptual diagram of a monitoring environment 100 within a retail space in which the mobile tag reader 140 is executing a location estimating routine. If the mobile tag reader 140 loses confidence in its position as it moves through the monitoring environment 100, or in other words does not recognize its visual surroundings, the mobile tag reader 140 may execute a locationing estimating routine to boost positional confidence. When executing this location estimating routine, the mobile tag reader 140 may first read tags 110 within the known antenna pattern or coverage range of the mobile tag reader 140. As shown in FIG. 4, the mobile tag reader 140 produces a known antenna pattern. Only the tags 110 that are within that antenna pattern will communicate with or receive communication from the mobile tag reader 140. Therefore, the mobile tag reader 140 only determines the position of tags 110 that are within the antenna pattern or coverage range of the mobile tag reader 140.

In some cases, the tags 110 may have overlapping read ranges 400. If the tags 110 have overlapping read ranges 400, this overlapping read range 400 may further assist the mobile tag reader 140 in estimating its location in the monitoring environment 100. In other words, the overlapping read ranges 400 may assist in narrowing down where the mobile tag reader 140 is located within the monitoring environment 100.

When the tags 110 within the antenna pattern or coverage range of the mobile tag reader 140 have been read, the mobile tag reader 140 will reference these tags 110 against the tags' previously stored tag information, if any. In some cases, this previously stored tag information is information that was read and detected when the mobile tag reader 140 moved through the monitoring environment 100 previously (e.g., previous inventory count cycles). The stored information associated with a previous read of the tag 110 may include the last determined position of the tag 110 in the monitoring environment 100. If the tags 110 have store positional information, this stored information may assist the mobile tag reader 140 in estimating its position in the monitoring environment 100.

If the tags 110 have no previously stored information to reference or if the positional confidence of the mobile tag reader 140 is not increased, the mobile tag reader 140 will continue moving through the monitoring environment 100 repeating the location estimating routine until positional confidence is restored or until the inventory count is complete, whichever is first.

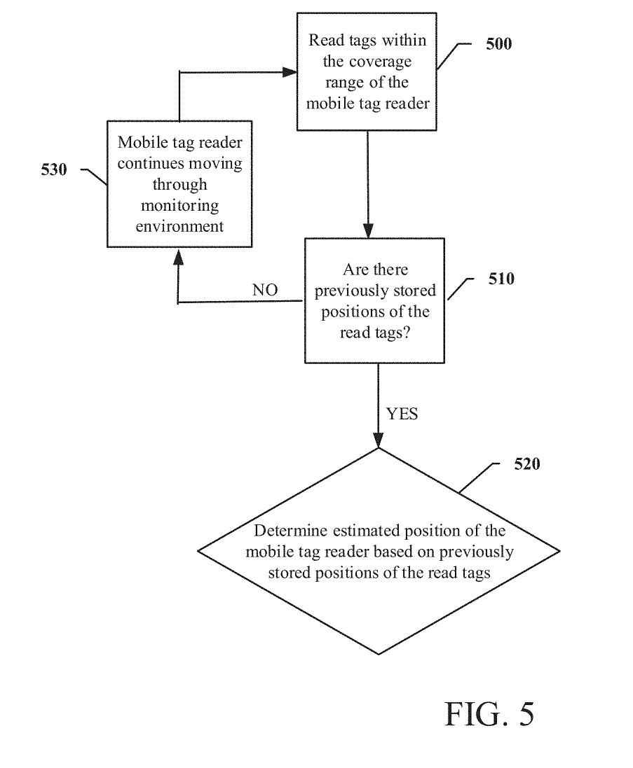

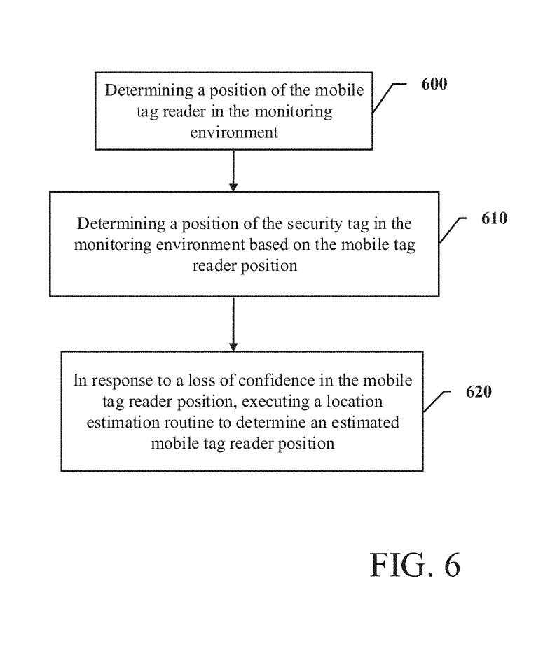

The platforms described in FIGS. 1-4 may be used to facilitate the implementation of several computer program and/or network communication based interactions. As an example, FIGS. 5 and 6 are flowcharts of example methods and program products according to an example embodiment. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a computing device and executed by a processor in the computing device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, FIG. 5 illustrates a block diagram showing a control flow representative of the location estimating routine executable at the mobile tag reader 140 in accordance with an example embodiment. As shown in FIG. 5, if the mobile tag reader 140 loses positional confidence, the mobile tag reader 140 may initially read tags within the antenna pattern or coverage range of the mobile tag reader 140 at operation 500. Then, the read tags 110 within the coverage range of the mobile tag reader 140 are referenced in relation to previously stored positional information of those read tags 110 at operation 510. If there are previously stored positions of the read tags 110, the mobile tag reader 140 may determine its estimated position in the monitoring environment 100 relative to those stored positions at operation 520, and positional confidence may be restored. In some cases, the read tags 110 may not have previously stored positional information. If so, at operation 530, the mobile tag reader 140 continues moving through the monitoring environment 100 reading tags 110 within its coverage range. The mobile tag reader 140 will continue the location estimating routine until positional confidence is increased or the inventory count cycle is complete, whichever is first.

FIG. 6 illustrates a block diagram of a method of performing a position estimation for the mobile tag reader in accordance with an example embodiment. The method may be executed by a positioning module 350 and tag reading module 340 located onboard the mobile tag reader 140. The positioning module 350 and tag reader 340 may include processing circuitry configured to perform the method of FIG. 6. The method may include determining the position of the mobile tag reader 140 in the monitoring environment 100 at operation 600. The method may further include determining the position of the tag 110 in the monitoring environment 100 based on the mobile tag reader position at operation 610. The method may further include, in response to a loss of confidence in the mobile tag reader position, executing a location estimating routine to determine an estimated mobile tag reader position at operation 620.

Example embodiments therefore represent a mobile tag reader that may be configured to, whenever the mobile tag reader loses positional confidence, estimate its position within the retail space, thereby increasing or restoring its positional confidence within the retail space. The mobile tag reader may include processing circuitry. The processing circuitry may be configured to determine a position of the mobile tag reader in the monitoring environment. The processing circuitry may be further configured to determine a position of the security tag in the monitoring environment based on the mobile tag reader position. The processing circuitry may be further configured to in response to a loss of confidence in the mobile tag reader position, execute a location estimating routine to determine an estimated mobile tag reader position.

In some embodiments, additional optional structures and/or features may be included or the structures/features described above may be modified or augmented. Each of the additional features, structures, modifications, or augmentations may be practiced in combination with the structures/features above and/or in combination with each other. Thus, some, all or none of the additional features, structures, modifications or augmentations may be utilized in some embodiments. Some example additional optional features, structures, modifications, or augmentations are described below, and may include, for example, that the processing circuitry is configured to determine the position of the mobile tag reader in the monitoring environment based on using visual recognition. In some cases, the visual recognition may be LIDAR. Alternatively or additionally, some embodiments may include that the loss of confidence in the mobile tag reader position is based on diminishing visual recognition in the monitoring environment. In a further example embodiment, the location estimating routine may include reading tags within the coverage range of the mobile tag reader, and referencing the tags read within the coverage range of the mobile tag reader to previously stored positions of the read tags. In some cases, the previously stored positions of the read tags are derived from previously determined positions of the security tag in the monitoring environment. Alternatively or additionally, some embodiments may include that the mobile tag reader is a robot. Alternatively or additionally, some embodiments may include that the mobile tag reader is a RFID reader.

Many modifications and other examples of the embodiments set forth herein will come to mind to one skilled in the art to which these embodiments pertain having the benefit of the teachings presented in the foregoing descriptions and the associated drawings. Therefore, it is to be understood that example embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A mobile tag reader configured to wirelessly communicate with a security tag in a monitoring environment, the mobile tag reader comprising processing circuitry configured to:
determine a position of the mobile tag reader in the monitoring environment;
determine a position of the security tag in the monitoring environment based on the mobile tag reader position; and
in response to a loss of confidence in the mobile tag reader position, execute a location estimating routine to determine an estimated mobile tag reader position.

2. The mobile tag reader of claim 1, wherein the processing circuitry is configured to determine the position of the mobile tag reader in the monitoring environment based on using visual recognition.

3. The mobile tag reader of claim 2, wherein the visual recognition is LIDAR.

4. The mobile tag reader of claim 1, wherein the loss of confidence in the mobile tag reader position is based on diminishing visual recognition in the monitoring environment.

5. The mobile tag reader of claim 1, wherein the location estimating routine comprises:
reading tags within the coverage range of the mobile tag reader; and
referencing the tags read within the coverage range of the mobile tag reader to previously stored positions of the read tags.

6. The mobile tag reader of claim 5, wherein the previously stored positions of the read tags are derived from previously determined positions of the security tag in the monitoring environment.

7. The mobile tag reader of claim 1, wherein the mobile tag reader is a robot.

8. The mobile tag reader of claim 1, mobile tag reader is an RFID tag reader.

9. A location estimating system comprising:
at least one security tag disposed on a product in a monitoring environment; and
at least one mobile tag reader configured to wirelessly communicate with a security tag, the mobile tag reader comprising processing circuitry configured to:
determine a position of the mobile tag reader in the monitoring environment;
determine a position of the security tag in the monitoring environment based on the mobile tag reader position; and
in response to a loss of confidence in the mobile tag reader position, execute a location estimating routine to determine an estimated mobile tag reader position.

10. The location estimating system of claim 9, wherein determining the mobile tag reader position in the monitoring zone is based on using visual recognition.

11. The location estimating system of claim 9, wherein the loss of confidence in the mobile tag reader position is based on diminishing visual recognition in the monitoring environment.

12. The location estimating system of claim 11, wherein the visual recognition is LIDAR.

13. The location estimating system of claim 9, wherein the location estimating routine comprises:
reading tags within the coverage range of the mobile tag reader; and
referencing the tags read within the coverage range of the mobile tag reader to previously stored positions of the tags.

14. The location estimating system of claim 13, wherein the previously stored positions of the tags are derived from previously determined positions of the security tag in the monitoring environment.

15. The location estimating system of claim 9, wherein the mobile tag reader is a robot.

16. The location estimating system of claim 9, wherein the mobile tag reader is an RFID tag reader.

17. A method of performing a location estimation for a tag reader, the method comprising:
determining a position of the mobile tag reader in the monitoring environment;
determining a position of the security tag in the monitoring environment based on the mobile tag reader position; and
in response to a loss of confidence in the mobile tag reader position, executing a location estimating routine to determine an estimated mobile tag reader position.

18. The method of claim 17, wherein determining the mobile tag reader position in the monitoring zone is based on using visual recognition.

19. The method of claim 17, wherein the loss of confidence in the mobile tag reader position is based on diminishing visual recognition in the monitoring environment.

20. The method of claim 17, wherein the location estimating routine comprises:
reading tags within the coverage range of the mobile tag reader; and
referencing the tags read within the coverage range of the mobile tag reader to previously stored positions of the tags.
